(19) United States
(12) Patent Application Publication
(10) Pub. No.: US 2024/0326491 A1
(43) Pub. Date: Oct. 3, 2024

(54) PRINTING DEVICE INCLUDING HOUSING HAVING ENGAGED PART AND REMOVABLE COVER HAVING ENGAGING PART

(71) Applicant: BROTHER KOGYO KABUSHIKI KAISHA, Nagoya (JP)

(72) Inventors: Sho ASAI, Nisshin (JP); Toshiyuki FURUYAMA, Chiryu (JP); Atsuo HIROSE, Nagoya (JP); Yusuke IKEMOTO, Nagoya (JP); Tomohiro WADA, Nagoya (JP); Tetsuro MURAMATSU, Nagoya (JP)

(21) Appl. No.: 18/614,557

(22) Filed: Mar. 22, 2024

(30) Foreign Application Priority Data
Mar. 30, 2023 (JP) 2023-055135

(51) Int. Cl. B41J 29/13; B41J 3/407

(52) U.S. Cl. CPC B41J 29/13; B41J 3/4075

(57) ABSTRACT

In a housing of a printing device, a second wall is arranged to oppose a first wall in a first direction and has an opening. An engaged part is provided at a third wall. A removable cover is detachably attached to the housing and includes: a first portion; and a second portion. The first portion covers the opening. The second portion has a first engaging part including a first sliding part. The first sliding part is movable between a first position and a second position and has a pawl. When the first sliding part is in the first position, the pawl is aligned with the engaged part in the first direction and is in contact with the engaged part. When the first sliding part is in the second position, the pawl is positioned away from the engaged part and is not aligned with the engaged part in the first direction.

### REFERENCE TO RELATED APPLICATIONS

This application claims priority from Japanese Patent Application No. 2023-055135 filed on Mar. 30, 2023. The entire content of the priority application is incorporated herein by reference.

### BACKGROUND ART

A conventional tape printing apparatus has a cassette accommodating section in which a tape cassette is mounted and a battery accommodating section in which a battery is mounted. The cassette accommodating section and battery accommodating section are open in the rear side of the lower apparatus body of the tape printing apparatus and are closed with a rear cover. The rear cover is provided with first insertion sections on the bottom edge and a second insertion section on the top edge. The second insertion section on the rear cover has a pawl section that protrudes upward. When closing the opening in the lower apparatus body with the rear cover, the first insertion parts are inserted into an insertion groove at the bottom of the opening formed in the lower apparatus body and the top end of the rear cover is brought toward the top of the opening formed in the lower apparatus body by pivotally moving the rear cover about the first insertion sections. A pawl fixing section is formed on the bottom of the top wall constituting the lower apparatus body. By fitting the pawl section on the second insertion part of the rear cover into the pawl fixing section inside the opening from below, the rear cover is placed in its closed state for closing the opening in the lower apparatus body.

### SUMMARY

To assist an operator in holding the tape printing apparatus with one hand, a belt may be attached at both ends to the respective top and bottom of the rear cover, for example. However, when the user carries the tape printing apparatus by holding the belt with the apparatus suspended therefrom, the rear cover may bend under the weight of the tape printing apparatus, deforming the rear cover into an arch shape between the ends of the belt. When such bending occurs, the second insertion part could separate from the top wall of the opening formed in the lower apparatus body, which could cause the pawl section to separate from the pawl fixing section and the rear cover to detach from the lower apparatus body. Further, even if a belt is not attached to the rear cover, the rear cover could still be bent from an impact or the like that could detach the rear cover from the lower apparatus body.

In view of the foregoing, it is an object of the present disclosure to provide a printing device with a removable cover that is unlikely to become detached inadvertently.

In order to attain the above and other object, the present disclosure provides a printing device. The printing device includes: a print head; a housing; and a removable cover. The print head is configured to perform printing on a print medium. The housing accommodates therein the print head. The housing includes: a first wall; a second wall; a third wall; and an engaged part. The second wall is arranged to oppose the first wall in a first direction. The second wall has an opening. The third wall connects the first wall to the second wall. The engaged part is provided at the third wall. The removable cover is detachably attached to the housing. The removable cover includes: a first portion; and a second portion. The first portion is configured to cover the opening. The first portion extends to cross the first direction. The second portion extends in the first direction. The second portion has a first engaging part. The first engaging part is configured to engage with the engaged part. The first engaging part includes: a first sliding part. The first sliding part is movable between a first position and a second position in a second direction crossing the first direction. The first sliding part has a pawl. When the first sliding part is in the first position, the pawl is aligned with the engaged part in the first direction and is in contact with the engaged part. When the first sliding part is in the second position, the pawl is positioned away from the engaged part and is not aligned with the engaged part in the first direction.

In the above structure, the pawl of the first engaging part will not disengage from the engaged part until the first sliding part has been moved from the first position to the second position in the second direction. If the user were to hold an accessory member attached to the removable cover, causing the removable cover to bend under the weight of the printing device, for example, the first engaging part may deform in a direction away from the third wall. However, since the second direction in which the first sliding part moves differs from the direction in which the first engaging part moves away from the third wall, the first engaging part can maintain the engagement between the pawl and engaged part even if the removable cover were to bend. Accordingly, the removable cover does not easily become detached from the housing.

### BRIEF DESCRIPTION OF DRAWINGS

FIG. 1 is a front view of a printing device.

FIG. 2 is a rear perspective view of the printing device to which a belt is attached.

FIG. 3 is an exploded perspective view of the printing device including a housing and a removable cover.

FIG. 4 is an explanatory diagram illustrating a top view and the internal configuration of a fixing part in which a second sliding part is disposed in a fixing position.

FIG. 5 is an explanatory diagram illustrating a top view and the internal configuration of the fixing part in which the second sliding part is disposed in a release position.

FIG. 6 is a rear perspective view of the printing device in which the removable cover has pivotally moved away from the housing.

FIG. 7 is an explanatory diagram illustrating a top view and the internal configuration of a fixing part in which a sliding part is disposed in a fixing position.

### DESCRIPTION

Hereinafter, a printing device 1 according to one embodiment of the present disclosure will be described while referring to the accompanying drawings.

The terms up, down, left, right, front, and rear indicated by arrows in the drawings will be used to specify directions in the following description from the perspective of a user operating an input unit 22 of the printing device 1. The printing device 1 is of a suitable size to be held by the user when operated. In other words, the printing device 1 is designed for handheld use.

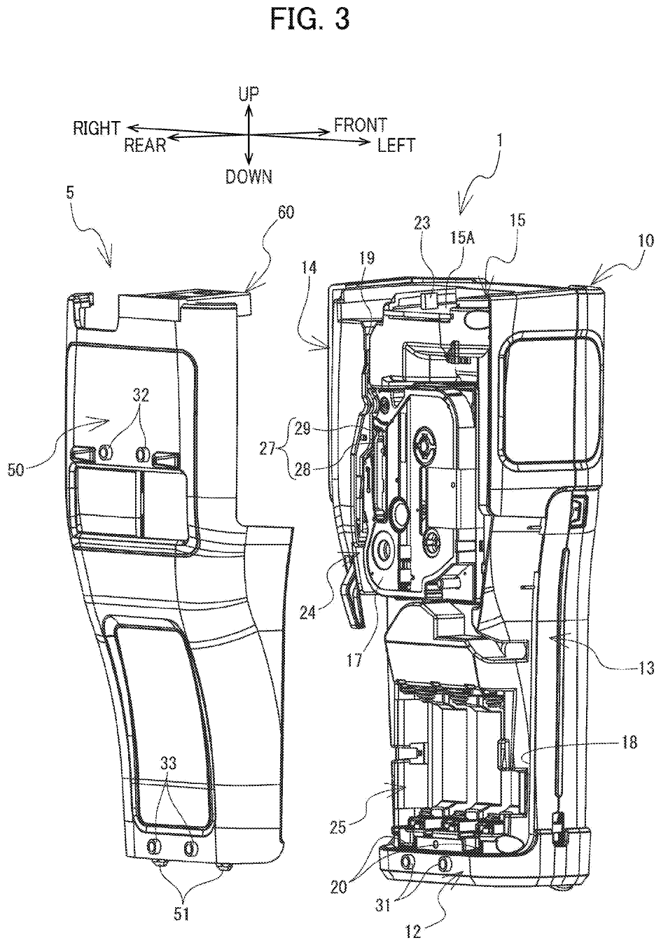

The printing device 1 can use various tape cassettes (a tape cassette 17, see FIG. 3) such as a receptor-type tape cassette, a thermal-type tape cassette, a laminate-type tape cassette, and a tube-type tape cassette. The tape cassette 17 holds a print medium in a continuous form. The print medium, which may include single-sided adhesive tape, thermal paper tape, double-sided adhesive tape, film tape, and tube tape, will be collectively referred to as “tape”. The printing device 1 can execute printing operations for printing alphabetic and other graphic characters on tape.

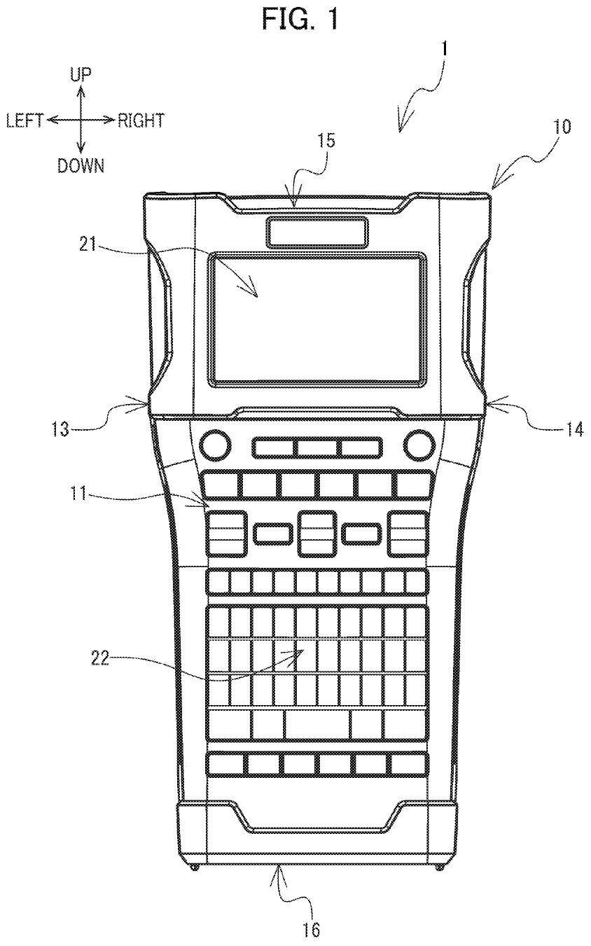

As illustrated in FIGS. 1 through 3, the printing device 1 includes a housing 10, a display unit 21, an input unit 22, and a removable cover 5. The housing 10 is box-shaped and elongated in an up-down direction. The housing 10 includes a front wall 11, a rear wall 12, a left wall 13, a right wall 14, a top wall 15, and a bottom wall 16. The front wall 11 is a wall disposed on the side that the user faces when operating the printing device 1. The display unit 21 is a liquid crystal display, for example, and can display various information. The display unit 21 is provided on the front wall 11 at a position above the approximate center of the front wall 11 in the up-down direction. The display unit 21 is a liquid crystal display, for example, and can display various information. The input unit 22 can accept various types of information inputted through user operations. The input unit 22 is provided on the front wall 11 at a position below the display unit 21.

The rear wall 12 of the housing 10 is formed with an opening 18. The opening 18 communicates with a cassette mounting section 24 in which a tape cassette 17 is mountable, and a battery mounting section 25 in which a battery (not illustrated) is mountable. The cassette mounting section 24 is provided at a position in the housing 10 above the approximate center of the housing 10 in the up-down direction. The battery mounting section 25 is provided at a position in the housing 10 below the cassette mounting section 24. The cassette mounting section 24 and battery mounting section 25 are recessed forward into the housing 10 and are exposed outside the housing 10 through the opening 18 formed in the rear wall 12. The tape cassette 17 and the battery are mounted in and removed from the respective cassette mounting section 24 and battery mounting section 25 in a front-rear direction at the rear of the housing 10.

A pair of insert nuts 31 is provided in the lower rear surface of the rear wall 12. One end portion of a belt 30 is attachable to the lower end portion of the rear wall 12 by inserting mounting screws 35 into the insert nuts 31 with the end portion of the belt 30 sandwiched therebetween. A pair of insert nuts 32 is also provided in the removable cover 5 described later. The other end portion of the belt 30 is attachable to the removable cover 5 by inserting mounting screws 35 into the insert nuts 32 with the other end portion of the belt 30 sandwiched therebetween. The belt 30 serves as an accessory for holding the printing device 1. The belt 30 extends in the up-down direction with a gap formed between the belt 30 and the housing 10. The user can hold the printing device 1 with one hand by inserting the hand between the housing 10 and belt 30. The belt 30 can remain connected to the housing 10 and removable cover 5, even when the removable cover 5 is removed from the housing 10.

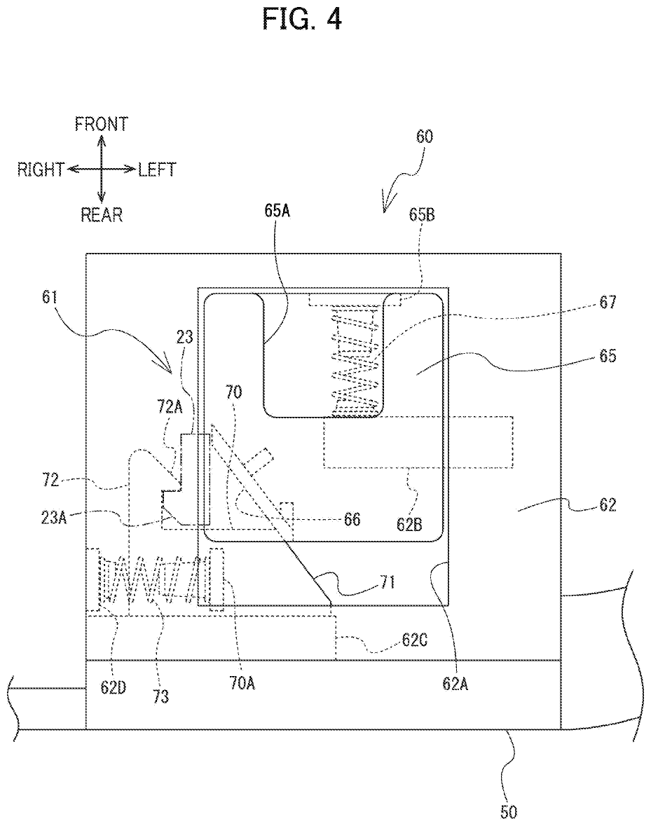

A seating portion 15A is formed in the top wall 15 of the housing 10. The seating portion 15A is a recessed area in the top wall 15 that conforms to the shape of a fixing part 60 (described later) of the removable cover 5. The fixing part 60 is placed in the seating portion 15A when the removable cover 5 is closed over the opening 18. A hook engaging part 23 described later is provided in the seating portion 15A. The hook engaging part 23 protrudes upward from the seating portion 15A. The hook engaging part 23 has a protruding portion 23A (see FIG. 4) that protrudes rightward from the rear edge thereof. The front surface of the protruding portion 23A is orthogonal to the front-rear direction. The rear surface of the protruding portion 23A slopes diagonally rearward and leftward.

A printing section 27 and a control section (not illustrated) are housed in the housing 10. The printing section 27 is arranged on the periphery of the cassette mounting section 24. The printing section 27 includes a print head 28, a platen roller 29, a drive motor (not illustrated), and the like. As the drive motor in the printing section 27 drives the platen roller 29, the platen roller 29 pulls tape out of the tape cassette 17 and conveys the tape while the tape is printed by the print head 28. The printed tape is discharged from the printing device 1 through an outlet 19 formed in the top wall 15. The control section is arranged in the housing 10 on the front side of the battery mounting section 25. The control section includes a CPU, ROM, RAM, and the like (not illustrated) and controls the drive of the printing device 1.

The removable cover 5 engages with the housing 10 in the opening 18 of the rear wall 12 and opens and closes the cassette mounting section 24 and battery mounting section 25. The removable cover 5 has a cover part 50 and a fixing part 60. In the following description, the removable cover 5 will be described on the basis of its orientation when attached to the housing 10.

The cover part 50 is a portion of the removable cover 5 that covers the opening 18 when the removable cover 5 is attached to the housing 10. The cover part 50 is a plate-shaped member elongated in the up-down direction so that its thickness dimension is oriented in the front-rear direction. Nearly the entire rear wall 12 of the housing 10 opens as the opening 18 when the removable cover 5 is removed, leaving only the lower end portion. The cover part 50 functions as the rear wall 12 of the housing 10 when covering the opening 18. Cross-shaped ribs (not illustrated) are formed on the inner surface (front surface) of the cover part 50 for reinforcing the cover part 50.

A pair of protrusions 51 is formed on the lower end portion of the cover part 50. The protrusions 51 are provided on the inner surface of the cover part 50 at positions separated from each other in the left-right direction. The protrusions 51 protrude downward from the inner surface of the cover part 50. The rear wall 12 of the housing 10 has an edge portion defining the opening 18, and a pair of engagement holes 20 is formed in the lower part of the edge portion. The engagement holes 20 are formed in the inner surface of the edge portion defining the opening 18 at positions separated from each other in the left-right direction. The engagement holes 20 are downwardly recessed into the inner surface of the edge portion. When the removable cover 5 is attached to the housing 10, the protrusions 51 are inserted into corresponding engagement holes 20, contacting the edge portion of the opening 18 to prevent the lower end portion of the cover part 50 from becoming detached. As will be described later, the protrusions 51 function as a supporting point when the removable cover 5 is pivotally moved to be open and closed.

A pair of insert nuts 32 and the pair of insert nuts 33 are provided in the rear side of the cover part 50. The insert nuts 32 are provided in the upper portion of the cover part 50, and the insert nuts 33 are provided in the lower end portion of the cover part 50. The user can attach both end portion of the belt 30 to the insert nuts 32 in the upper portion of the cover part 50 and the insert nuts 33 in the lower end portion of the cover part 50 for aiding the user in holding the printing device 1. With this configuration, the user can insert a hand between the housing 10 and belt 30 and hold the printing device 1 with one hand. Furthermore, when replacing the tape cassette 17 or the battery, the user can remove the belt 30 from the housing 10 together with the removable cover 5.

The fixing part 60 is a portion of the removable cover 5 that fixes the removable cover 5 when the removable cover 5 is closed over the opening 18 so that the removable cover 5 does not become detached from the housing 10. The fixing part 60 is a plate-shaped member extending in the front-rear direction so that its thickness dimension is oriented in the up-down direction. The fixing part 60 is connected to the upper end of the cover part 50 and extends frontward therefrom. The fixing part 60 includes a locking mechanism 61. When the removable cover 5 is closed over the opening 18, the locking mechanism 61 engages with the hook engaging part 23 formed in the seating portion 15A of the top wall 15.

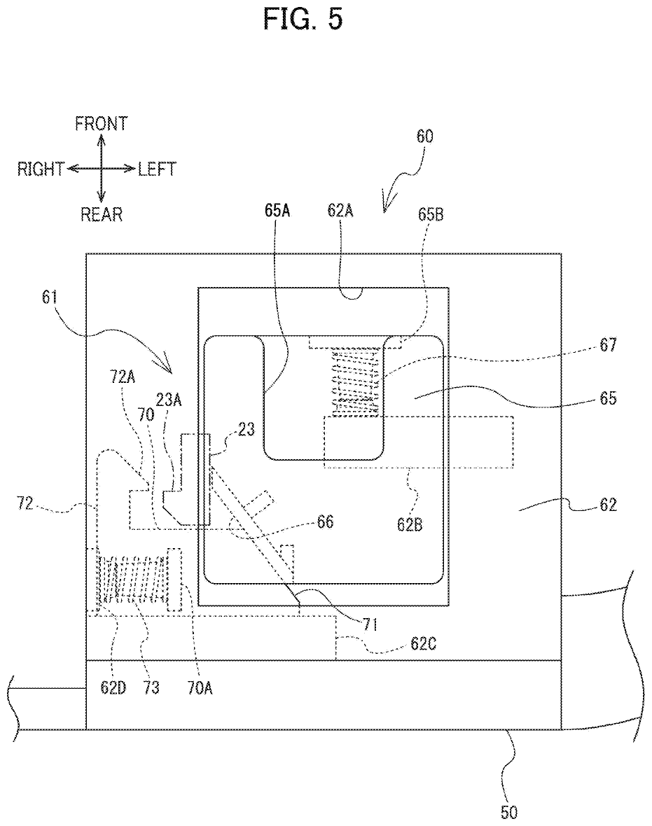

The locking mechanism 61 will be described next with reference to FIGS. 4 and 5. The locking mechanism 61 includes a body 62, a first sliding part 65, a second sliding part 70, and springs 67 and 73. The body 62 is the main part of the locking mechanism 61 that holds the other parts of the locking mechanism 61. The body 62 has a thick rectangular plate shape. A guiding recess 62A is formed in the upper surface of the body 62 approximately in the center thereof. The guiding recess 62A has a rectangular concave shape and is elongated in the front-rear direction. The first sliding part 65 is arranged inside the guiding recess 62A. The guiding recess 62A guides the first sliding part 65 so that the first sliding part 65 is movable in the front-rear direction. The first sliding part 65 is plate-shaped and substantially square in a plan view. The corners of the first sliding part 65 are rounded. In other words, the corners of the first sliding part 65 have been round chamfered. A finger hooking portion 65A is formed in the upper surface of the first sliding part 65. The finger hooking portion 65A is a recess that the user hooks with a finger to move the first sliding part 65 rearward within the guiding recess 62A.

A supporting portion 65B is provided on the lower surface of the first sliding part 65 along the front end portion thereof. The front end portion of the spring 67, which can expand and contract in the front-rear direction, is supported by the supporting portion 65B. The rear end portion of the spring 67 is supported by a supporting portion 62B of the body 62 provided inside the guiding recess 62A. The spring 67 urges the first sliding part 65 frontward within the guiding recess 62A in order to move the first sliding part 65 to a front end position within the moving range of the first sliding part 65 in the front-rear direction. When the user moves the first sliding part 65 rearward, the first sliding part 65 is placed in a rear end position within the moving range of the first sliding part 65 in the front-rear direction.

A sloped surface 66 is provided along the lower surface of the first sliding part 65 in the right-rear corner thereof. The sloped surface 66 faces diagonally rearward and rightward. The sloped surface 66 protrudes downward from the lower surface of the first sliding part 65 and extends from the right edge portion to the rear edge portion of the first sliding part 65. The sloped surface 66 contacts a sloped surface 71 (described later) of the second sliding part 70.

The body 62 has a guiding base 62C disposed rearward relative to the guiding recess 62A. The guiding base 62C extends in the left-right direction for guiding movement of the second sliding part 70 in the left-right direction. The second sliding part 70 has a body that is a thick plate-shaped member extending in the left-right direction. The body of the second sliding part 70 is disposed below the first sliding part 65 at a position rightward and rearward relative to the first sliding part 65. The second sliding part 70 further has a sloped surface 71, and a hook part 72.

The sloped surface 71 is formed on the left end portion of the body of the second sliding part 70. The sloped surface 71 extends from the right-front of the body of the second sliding part 70 toward the left-rear corner of the second sliding part 70 and faces diagonally frontward and leftward. The sloped surface 71 faces the sloped surface 66, with the two surfaces contacting each other. The hook part 72 is provided on the right end portion of the body of the second sliding part 70 and extends frontward. A protruding portion 72A is provided on the distal end portion of the hook part 72 and protrudes leftward therefrom. The rear surface of the protruding portion 72A is orthogonal to the front-rear direction. The front surface of the protruding portion 72A slopes diagonally frontward and rightward.

A support part 70A is provided on the lower surface of the body of the second sliding part 70 in the approximate center region in the left-right direction of the body of the second sliding part 70. The left end portion of the spring 73, which expands and contracts in the left-right direction, is supported by the support part 70A. The right end portion of the spring 73 is supported by a support part 62D provided at the right-rear portion of the body 62. The spring 73 urges the second sliding part 70 leftward along the front surface of the guiding base 62C for placing the second sliding part 70 in a fixing position, which is the leftmost position within the moving range of the second sliding part 70 in the left-right direction. When the second sliding part 70 is in the fixing position, the protruding portion 72A of the hook part 72 is aligned in the front-rear direction with the protruding portion 23A of the hook engaging part 23, and the rear surface of the protruding portion 72A faces the front surface of the protruding portion 23A. When the fixing part 60 incurs stress or a force in the rearward direction which is the direction for detaching the removable cover 5, the protruding portion 72A comes into contact with the protruding portion 23A from the front side and the protruding portion 23A restricts rearward movement of the fixing part 60. When the user moves the first sliding part 65 rearward, the second sliding part 70 is pushed rightward through the contact between the sloped surfaces 66 and 71. Once the first sliding part 65 is in the rear end position, the second sliding part 70 is in a release position, which is the rightmost position within the moving range of the second sliding part 70 in the left-right direction. When the second sliding part 70 is in the release position, the protruding portion 72A of the hook part 72 is positioned off rightward relative to the position in which the protruding portion 72A aligns in the front-rear direction with the protruding portion 23A of the hook engaging part 23 (see FIG. 5). At this time, the protruding portion 72A is no longer aligned with the protruding portion 23A in the front-rear direction and is no longer in contact with the protruding portion 23A.

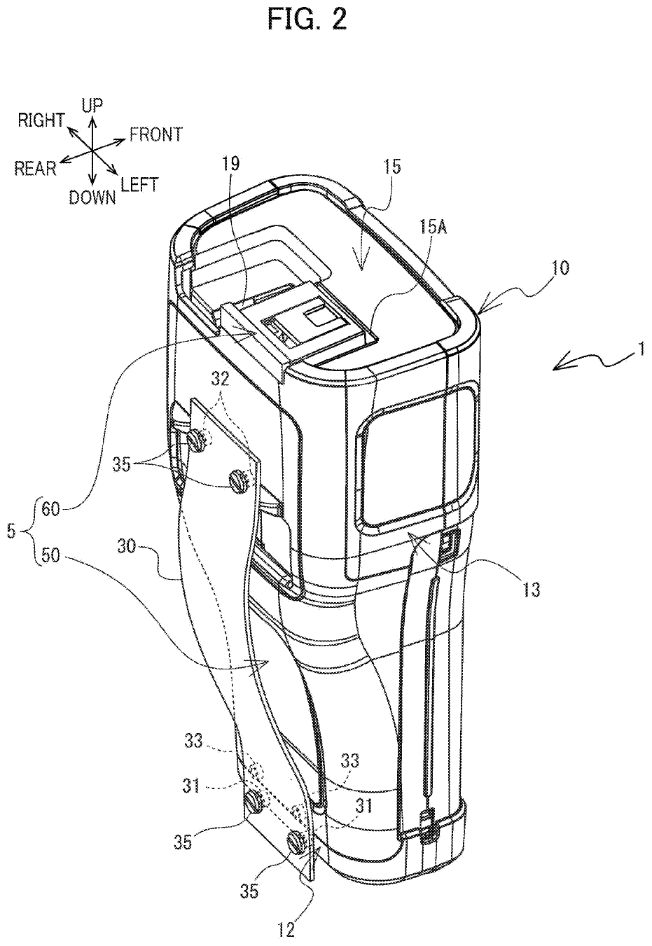

When the user holds the belt 30 (see FIG. 2) with the printing device 1 suspended therefrom, the weight of the printing device 1 is applied to parts on the upper end portion and lower end portion of the removable cover 5 to which the belt 30 is engaged. When the removable cover 5 bends into an arch shape along the up-down direction at this time, the hook part 72 of the second sliding part 70 will move relative to the hook engaging part 23 in the up-down direction. However, the printing device 1 according to the present embodiment is configured so that the hook part 72 of the second sliding part 70 disengages from the hook engaging part 23 by moving in the left-right direction. Therefore, the hook part 72 and hook engaging part 23 will not disengage, even if the removable cover 5 is bent into an arch shape.

Next, operations involved with the opening and closing of the removable cover 5 will be described. When the removable cover 5 is closed over the opening 18 in the housing 10, as illustrated in FIGS. 2 and 4, the fixing part 60 is positioned in the seating portion 15A, which is formed as a recess in the top wall 15. The first sliding part 65 is urged frontward relative to the body 62 by the spring 67. At this time, the first sliding part 65 is in the front end position within the guiding recess 62A. Additionally, the second sliding part 70 is urged leftward relative to the body 62 by the spring 73. At this time, the second sliding part 70 is in the fixing position along the guiding base 62C.

The protruding portion 72A provided on the hook part 72 of the second sliding part 70 is positioned on the front side of the protruding portion 23A of the hook engaging part 23 provided in the seating portion 15A. Hence, the protruding portion 72A and protruding portion 23A are aligned in the front-rear direction. In other words, by engaging with the hook engaging part 23, the locking mechanism 61 restricts the fixing part 60 from moving rearward. Accordingly, the upper side of the removable cover 5 does not move rearward relative to the housing 10.

Additionally, the protrusions 51 provided on the lower end portion of the removable cover 5 are engaged in the engagement holes 20 formed in the lower part of the edge portion defining the opening 18 formed in the housing 10. By contacting the edge portion defining the opening 18, the protrusions 51 restrict the lower end portion of the removable cover 5 from moving rearward. Accordingly, the lower side of the removable cover 5 does not move rearward relative to the housing 10. Thus, the removable cover 5 can be maintained in a closed state over the opening 18 in the housing 10.

Next, to open the removable cover 5, the user places a finger in the finger hooking portion 65A of the first sliding part 65 and moves the first sliding part 65 rearward into the rear end position. As the first sliding part 65 moves rearward, the sloped surface 66 presses the sloped surface 71 of the second sliding part 70 diagonally rearward and rightward, as illustrated in FIG. 5. The stress or force received by the sloped surface 71 causes the second sliding part 70 to move rightward along the guiding base 62C into the release position. As a result, the protruding portion 72A of the hook part 72 is moved outside the position in which the protruding portion 72A of the hook part 72 aligns in the front-rear direction with the protruding portion 23A of the hook engaging part 23. In other words, the locking mechanism 61 and hook engaging part 23 are disengaged from each other, allowing the fixing part 60 to move rearward relative to the seating portion 15A.

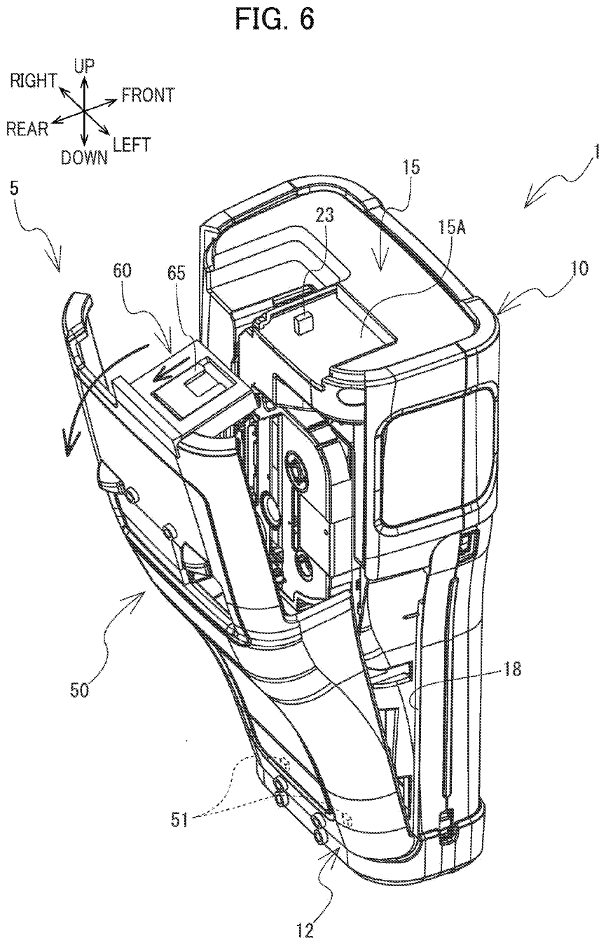

The direction in which the user moves the first sliding part 65, i.e., the rearward direction, is the same direction in which the fixing part 60 can separate from the seating portion 15A. Therefore, as the user moves the first sliding part 65 rearward, the upper end portion of the removable cover 5 also moves rearward. At this time, the protrusions 51 remain engaged in the engagement holes 20 and are in contact with the edge portion defining the opening 18. As the upper end portion of the removable cover 5 moves rearward, the removable cover 5 pivotally moves counterclockwise in a left-side view about the protrusions 51 that are in contact with the edge portion defining the opening 18, as illustrated in FIG. 6. Once the removable cover 5 has pivotally moved away from the housing 10, the user can pull the protrusions 51 out of the engagement holes 20 to remove the removable cover 5 from the housing 10 and expose the opening 18 formed in the housing 10. Thus, the direction in which the upper end portion of the removable cover 5 moves when the user begins to pivotally move the removable cover 5 to expose the opening 18 is the same as the direction in which the user moves the first sliding part 65 for disengaging the locking mechanism 61 from the hook engaging part 23. Therefore, the user can release the locking mechanism 61 and open the removable cover 5 through one operation.

As described above, the hook part 72 of the locking mechanism 61 will not disengage from the hook engaging part 23 until the second sliding part 70 has been moved rightward from the fixing position to the release position. If the user were to hold the belt 30 attached to the removable cover 5, causing the removable cover 5 to bend under the weight of the printing device 1, for example, the locking mechanism 61 may deform in a direction away from the top wall 15. However, since the left-right direction in which the second sliding part 70 moves differs from the rearward direction in which the locking mechanism 61 separates from the top wall 15, the locking mechanism 61 can maintain the engagement between the hook part 72 and hook engaging part 23 even if the removable cover 5 were to bend. Accordingly, the removable cover 5 does not easily become detached from the housing 10.

The user moves the locking mechanism 61 rearward when opening the removable cover 5. The first sliding part 65 is also moved rearward from the front end position to the rear end position when disengaging the locking mechanism 61. At this time, the second sliding part 70, which follows the movement of the first sliding part 65, moves from the fixing position to the release position to disengage the hook part 72 from the hook engaging part 23. In other words, the direction in which the first sliding part 65 is moved to disengage the hook part 72 from the hook engaging part 23 is the same as the direction in which the locking mechanism 61 moves when the removable cover 5 begins to open. Accordingly, the user can easily open the removable cover 5 from its closed state simply by moving the first sliding part 65 in the direction for opening the removable cover 5.

The spring 73 urges the second sliding part 70 toward the fixing position so that the second sliding part 70 is in the fixing position. In other words, the spring 73 urges the second sliding part 70 into the fixing position. Therefore, the hook part 72 can reliably engage the hook engaging part 23 when the removable cover 5 is closed. Hence, the removable cover 5 of the printing device 1 is unlikely to become detached from the housing 10.

The spring 67 urges the first sliding part 65 toward the front end position so that the first sliding part 65 is in the front end position. In other words, the spring 67 urges the first sliding part 65 into the front end position. Therefore, the hook part 72 of the second sliding part 70, which follows the movement of the first sliding part 65, can reliably engage the hook engaging part 23 when the removable cover 5 is closed. Accordingly, the removable cover 5 of the printing device 1 is unlikely to become detached from the housing 10.

The first sliding part 65 has the sloped surface 66, and the second sliding part 70 has the sloped surface 71 that faces the opposite direction to the direction in which the sloped surface 66 faces and is in contact with the sloped surface 66. Therefore, the locking mechanism 61 can make the second sliding part 70 follow movement of the first sliding part 65 through a simple configuration.

The left-right direction in which the second sliding part 70 moves differs from the rearward direction in which the locking mechanism 61 moves away from the top surface 15. Therefore, the locking mechanism 61 can maintain the engagement between the hook part 72 and hook engaging part 23, even if the removable cover 5 were to be bent. Accordingly, the removable cover 5 of the printing device 1 is unlikely to become detached from the housing 10.

With the locking mechanism 61 and the protrusions 51 engaged in the housing 10, the removable cover 5 can be maintained in its closed state over the opening 18. Accordingly, the removable cover 5 of the printing device 1 is unlikely to become detached from the housing 10.

By moving the locking mechanism 61 in the front-rear direction that is the same as the direction in which the first sliding part 65 is moved, the user can open and close the removable cover 5 so that the removable cover 5 exposes and covers the opening 18 through a single operation performed in the same direction in which the removable cover 5 is pivotally moved about the protrusions 51.

By attaching a belt 30 to the insert nuts 32 in the removable cover 5, the user can hold the housing 10 of the printing device 1 by hand with the aid of the belt 30.

The user can attach one end portion of the belt 30 to the insert nuts 31 in the housing 10 and the other end portion of the belt 30 to the insert nuts 32 in the removable cover 5. This configuration prevents the body of the printing device 1 from being dropped while the user continues to hold the removable cover 5, even if the removable cover 5 were to become detached from the housing 10 due to mishandling or other reasons. The user can also hold the housing 10 of the printing device 1 with one hand by inserting the hand between the belt 30 and removable cover 5.

The user can also attach one end portion of the belt 30 to the insert nuts 33 in the removable cover 5 and the other end portion of the belt 30 to the insert nuts 32 in the removable cover 5. With this arrangement, the belt 30 is unlikely to hinder the user's operations for opening the removable cover 5. The user can also hold the housing 10 of the printing device 1 with one hand by inserting the hand between the belt 30 and removable cover 5.

In the above embodiment, the print head 28 is an example of the print head of the present disclosure. The housing 10 is an example of the present disclosure. The front wall 11 is an example of the first wall of the present disclosure. The rear wall 12 is an example of the second wall of the present disclosure. The opening 18 is an example of the opening of the present disclosure. The top wall 15 is an example of the third wall of the present disclosure. The hook engaging part 23 is an example of the engaged part of the present disclosure. The removable cover 5 is an example of the removable cover of the present disclosure. The cover part 50 is an example of the first portion of the present disclosure. The fixing part 60 is an example of the second portion of the present disclosure. The second sliding part 70 is an example of the first sliding part of the present disclosure. The hook part 72 is an example of the pawl of the present disclosure. The first sliding part 65 is an example of the second sliding part of the present disclosure. The spring 73 is an example of the first urging member of the present disclosure. The spring 67 is an example of the second urging member of the present disclosure. The sloped surface 71 is an example of the first sloped surface of the present disclosure. The sloped surface 66 is an example of the second sloped surface of the present disclosure. The protrusions 51 are an example of the second engaging part of the present disclosure. The insert nuts 32 are an example of the first mounting part of the present disclosure. The insert nuts 31 are an example of the second mounting part of the present disclosure. The insertion nuts 33 are an example of the second mounting part of the present disclosure. The belt 30 is an example of the accessory member of the present disclosure. The fixing position is an example of the first position of the present disclosure. The release position is an example of the second position of the present disclosure. The front end position is an example of the third position of the present disclosure. The rear end position is an example of the present disclosure. The front-rear direction is an example of the first direction of the present disclosure. The left-right direction is an example of the second direction of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, while the belt 30 is used as an example of the accessory member in the above embodiment, a strap or an arm member having a fixed shape may be attached to the insert nuts 31 through 33 for use as an accessory member. Alternatively, the printing device 1 may be provided with shaft-like members, and the belt 30 or a strap may be attachable to the shaft-like members instead of the insert nuts 31 through 33. Alternatively, the shaft-like members may be attached to the insert nuts 31 through 33.

The spring 67 for urging the first sliding part 65 may be omitted from the locking mechanism 61. In this case, the spring 73 of the second sliding part 70 should have sufficient urging force to press the second sliding part 70 toward the fixing position while at the same time pressing the first sliding part 65 toward the front end position via the sloped surfaces 71 and 66 when the user's finger is lifted from the first sliding part 65. Additionally, the locking mechanism 61 may be formed with left-right symmetry, and two hook engaging parts 23 having left-right symmetry may be provided in the seating portion 15A.

While the seating portion 15A in which the fixing part 60 is placed when the removable cover 5 is closed is provided in the top wall 15 of the housing 10, the seating portion 15A may instead be provided in the left wall 13, the right wall 14, or the bottom wall 16 of the housing 10. Note that if the seating portion 15A is provided in the left wall 13 or the right wall 14, the second sliding part 70 should be movable in the up-down direction.

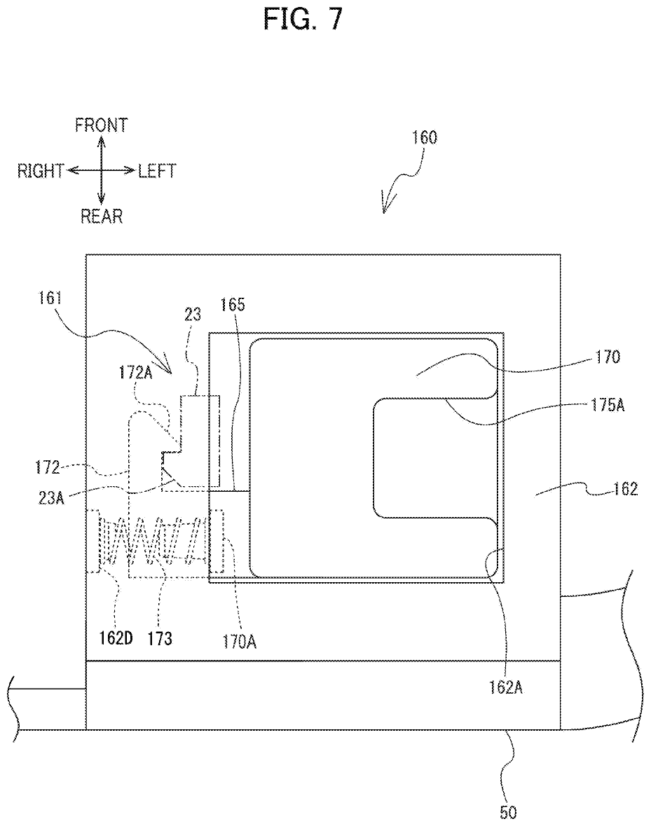

As an alternative, the first sliding part 65 may be moved in the left-right direction that is the same as the direction in which the second sliding part 70 is moved, while the upper end portion of the removable cover 5 is moved rearward to open the removable cover 5. FIG. 7 illustrates an example of a fixing part 160 applying this modification. The fixing part 160 includes a locking mechanism 161. The locking mechanism 161 includes a body 162, a sliding part 170, and a spring 173. The body 162 has a guiding recess 162A in the approximate center of the upper surface thereof. The guiding recess 162A has a rectangular concave shape and is elongated in the left-right direction. The sliding part 170 has a body that is arranged inside the guiding recess 162A. The guiding recess 162A guides the sliding part 170 so that the sliding part 170 is movable in the left-right direction. A finger hooking part 175A is formed in the upper surface of the body of the sliding part 170. The finger hooking part 175A is a recess that the user hooks with a finger to move the body of the sliding part 170 rightward within the guiding recess 162A. The sliding part 170 includes an extended portion 165 that extends rightward from the right-rear corner of the body of the sliding part 170. A hook part 172 is provided on the right end portion of the extended portion 165 and extends frontward therefrom. A protruding portion 172A is provided on the distal end portion of the hook part 172 and protrudes leftward therefrom. A support part 170A is provided on the lower surface of the sliding part 170 in the approximate center region in the front-rear direction of the extended portion 165. The spring 173 is supported between the support part 170A and a support part 162D provided in the right rear portion of the body 162.

While the removable cover 5 is closed over the opening 18 in the housing 10, the spring 173 urges the sliding part 170 into the fixing position in the left end portion of the guiding recess 162A. At this time, the protruding portion 172A is positioned on the front side of the protruding portion 23A of the hook engaging part 23 and is aligned with the protruding portion 23A in the front-rear direction. Therefore, the locking mechanism 161 restricts rearward movement of the fixing part 160. To open the removable cover 5, the user places a finger in the finger hooking part 175A of the sliding part 170 and moves the sliding part 170 rightward into the release position. As a result, the protruding portion 172A of the hook part 172 is moved outside the position in which the protruding portion 172A of the hook part 172 aligns in the front-rear direction with the protruding portion 23A of the hook engaging part 23. Therefore, the locking mechanism 161 is disengaged from the hook engaging part 23, allowing the fixing part 160 to move rearward. The removable cover 5 then pivotally moves about the protrusions 51 to expose the opening 18.

In the modification described above, the direction for opening the removable cover 5 differs from the direction for disengaging the hook part 172 from the hook engaging part 23. Therefore, the removable cover 5 is not placed in the open state simply by being pressed from the outside on the finger hooking part 175A and is less likely to be placed in the open state even when mishandled. Furthermore, the sliding part 170 is urged into the fixing position to ensure that the hook part 172 is reliably engaged with the hook engaging part 23 when the removable cover 5 is closed. Accordingly, the removable cover 5 of the printing device 1 does not easily become detached from the housing 10.

In the above modification, the finger hooking part 175A is an example of the operation part of the present disclosure. The spring 173 is an example of the urging member of the present disclosure.

In the above modification, two each of the locking mechanisms 161 and hook engaging parts 23 may be provided in an arrangement with left-right symmetry.

What is claimed is:

1. A printing device comprising:
a print head configured to perform printing on a print medium;
a housing accommodating therein the print head, the housing comprising:
a first wall;
a second wall arranged to oppose the first wall in a first direction, the second wall having an opening;
a third wall connecting the first wall to the second wall; and
an engaged part provided at the third wall; and
a removable cover detachably attached to the housing, the removable cover comprising:
a first portion configured to cover the opening, the first portion extending to cross the first direction; and
a second portion extending in the first direction, the second portion having a first engaging part configured to engage with the engaged part, the first engaging part comprising:
a first sliding part movable between a first position and a second position in a second direction crossing the first direction, the first sliding part having a pawl,
wherein when the first sliding part is in the first position, the pawl is aligned with the engaged part in the first direction and is in contact with the engaged part, and
wherein when the first sliding part is in the second position, the pawl is positioned away from the engaged part and is not aligned with the engaged part in the first direction.

2. The printing device according to claim 1,
wherein the first engaging part further comprises:
a second sliding part movable between a third position and a fourth position in the first direction while the first portion covers the opening,
wherein the first sliding part is configured to move in the second direction following movement of the second sliding part, and
wherein when the second sliding part is in the third position, the first sliding part is in the first position, and when the second sliding part is in the fourth position, the first sliding part is in the second position.

3. The printing device according to claim 2,
wherein the first engaging part further comprises:
a first urging member configured to urge the first sliding part into the first position.

4. The printing device according to claim 3,
wherein the first engaging part further comprises:
a second urging member configured to urge the second sliding part into the third position.

5. The printing device according to claim 4,
wherein the first sliding part has a first sloped surface, the first sloped surface facing in a first facing direction, the first facing direction being a direction diagonally toward the third position in the first direction and toward the first position in the second direction, and
wherein the second sliding part has a second sloped surface, the second sloped surface facing in a second facing direction opposite the first facing direction, the second sloped surface being in contact with the first sloped surface.

6. The printing device according to claim 1,
wherein the first sliding part has an operation part configured to receive an operation to move the first sliding part from the first position to the second position.

7. The printing device according to claim 6,
wherein the first engaging part further comprises:
an urging member configured to urge the first sliding part toward the first position.

8. The printing device according to claim 1,
wherein the third wall has an outer surface extending in the second direction.

9. The printing device according to claim 8,
wherein the second portion is provided at one end portion of the first portion, another end portion of the first portion being positioned closer to the third wall than the another end portion of the first portion is to the third wall while the first portion covers the opening,
wherein the first portion has a second engaging part at the another end portion of the first portion, and
wherein the second wall has an edge portion defining the opening, the second engaging part being in contact with the edge portion while the first portion covers the opening.

10. The printing device according to claim 9,
wherein the removable cover is movable between a closed state and an open state by pivotally moving about the second engaging part with the second engaging part in contact with the edge portion, the first portion covering the opening while the removable cover is in the closed state, the first portion not covering the opening while the removable cover is in the open state.

11. The printing device according to claim 10,
wherein the removable cover further comprises a first mounting part to which an accessory member used for holding the printing device with hand is attachable.

12. The printing device according to claim 11,
wherein the housing further comprises a second mounting part to which the accessory member is attachable, the second mounting part being provided in an outer surface of the second wall and being positioned on an opposite side of the opening from the third wall,
wherein the first mounting part is provided in an outer surface of the one end portion of the first portion, and
wherein the accessory member is used for holding the printing device with one hand while one end portion of the accessory member is attached to the first mounting part and another end portion of the accessory member is attached to the second mounting part.

13. The printing device according to claim 11,
wherein the removable cover further comprises a second mounting part to which the accessory member is attachable, the second mounting part being provided in an outer surface of the another end portion of the first portion,
wherein the first mounting part is provided in an outer surface of the one end portion of the first portion, and
wherein the accessory member is used for holding the printing device with one hand while one end portion of the accessory member is attached to the first mounting part and another end portion of the accessory member is attached to the second mounting part.
